(19) United States
(12) Patent Application Publication
(10) Pub. No.: US 2005/0216920 A1
(43) Pub. Date: Sep. 29, 2005

(54) Use of a virtual machine to emulate a hardware device

(76) Inventors: Vijay Tewari, Portland, OR (US); Scott H. Robinson, Portland, OR (US); Gustavo P. Espinosa, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/808,991

(22) Filed: Mar. 24, 2004

(51) Int. Cl. G06F 9/46

(52) U.S. Cl. 719/324

(57) ABSTRACT

A device virtual machine (VM) is configured to emulate a hardware device. The device VM includes device emulation code used to emulate the hardware device.

### BACKGROUND

A conventional virtual machine monitor (VMM) typically runs on a computer and presents to other software the abstraction of one or more virtual machines (VM). Each virtual machine may function as a self-contained platform, running its own “guest operating system” and other software, collectively referred to as guest software. The guest software expects to operate as if it were running on a dedicated computing machine. That is, the guest software expects to control various events and have access to hardware resources. The hardware resources may include processor-resident resources (e.g., control registers), resources that reside in memory (e.g., descriptor tables) and resources that reside on the underlying hardware platform (e.g., input-output devices). The events may include internal interrupts, external interrupts, exceptions, platform events (e.g., initialization (INIT) or system management interrupts (SMIs)), and the like.

In a virtual machine environment, the VMM should be able to have ultimate control over the events and hardware resources (such as described in the previous paragraph) to provide proper operation of guest software running on the virtual machines and for protection from and among guest software components running on the virtual machines. Typically the VMM presents only a virtual platform to the virtual machines and arbitrates access to the underlying resources to allow for sharing of those resources by the VM's. To achieve this, the VMM typically receives control when guest software accesses a protected resource (e.g., page directory base control register) or when other events (such as interrupts or exceptions) occur. For example, when an operation in a virtual machine supported by the VMM causes a system device to generate an interrupt, the currently running virtual machine is interrupted and control of the processor is passed to the VMM. The VMM then receives the interrupt, and handles the interrupt itself or invokes an appropriate virtual machine and delivers the interrupt to that virtual machine.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of a virtual machine environment, in which some embodiments of the present invention may operate;

FIG. 2 is a flow diagram of one embodiment of a process for launching a new client VM and dynamically assigning a device VM to emulate the required hardware device in a virtual machine environment; and

FIG. 3 is a flow diagram of one embodiment of a process for configuring the device virtual machine (VM) to emulate a desired hardware device.

### DESCRIPTION OF EMBODIMENTS

A method and system for emulating a hardware device in a virtual machine environment are described. More specifically, a method and system for providing a way in which the VMM and the VMs can be used as a mechanism for emulating hardware devices that are used to perform specialized functions or to emulate hardware devices that are not yet available or too expensive are described. Examples of hardware devices cover the spectrum from “smart” to “dumb” and can include, but are not limited to, programmable logic arrays (PLA's), field programmable gate arrays (FPGA's), I/O devices, coprocessors, I/O processors, PCI cards, offload engines and the like. In the following description, for purposes of explanation, numerous specific details are set forth. It will be apparent, however, to one skilled in the art that embodiments of the invention can be practiced without these specific details.

Embodiments of the present invention may be implemented using software, firmware, microcode, hardware, etc., or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer), but is not limited to, floppy diskettes, optical disks, Compact Disc Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer-system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments.

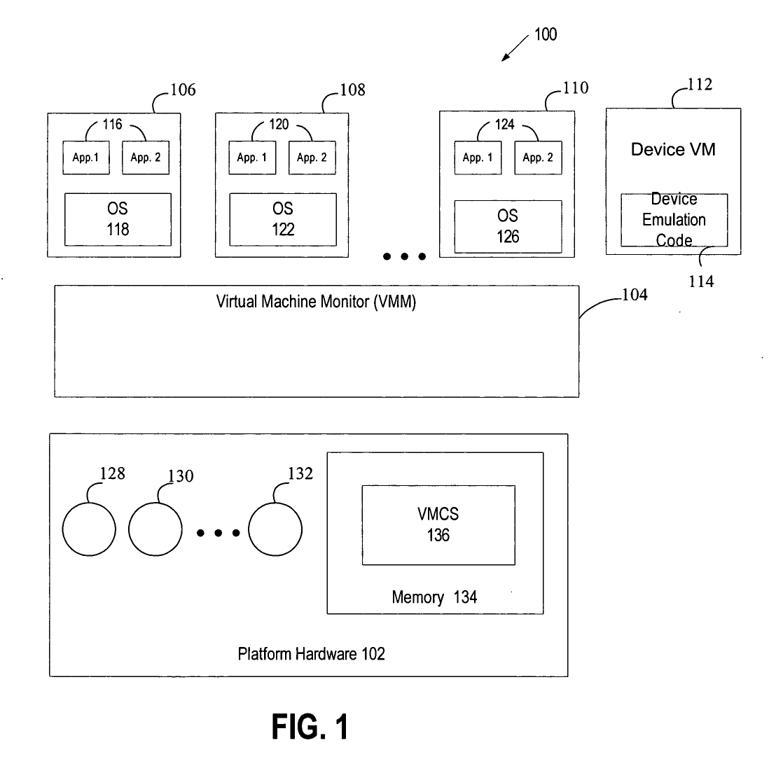

FIG. 1 illustrates a virtual machine environment 100, in which some embodiments of the present invention may operate. The virtual machine environment 100 includes, but is not necessarily limited to, platform hardware 102, a virtual machine monitor (VMM) 104, one or more virtual machines (VM) 106, 108 and 110 and a device VM 112. VM 106, 108 and 110 and device VM 112 are hosted by VMM 104. The platform hardware 102 may include, but is not limited to, one or more processors 128, 130 and 132 and memory 134. The memory 134 includes a virtual machine control structure (VMCS) 136. VMCS 136 determines VM 106, 108 and 110, device VM 112 and VMM 104 actions and behaviors (e.g., whether certain instructions, resources or events are virtualized or not, determines control transfers between (for example) the VM's and the VMM, and determines state saved or restored during such transitions). VM 106, 108 and 110 and device VM 112 may share common controls and/or have their own custom controls. Thus, each VM 106, 108 and 110 may have its own VMCS in virtual machine environment 100. Each VM 106, 108 and 110 includes guest software and may include a guest operating system (OS) such as a guest OS 118, 122 and 126 and various guest software applications 116, 120 and 124. The device VM 112 includes device emulation code 114. Each of these components is described next in more detail.

In the virtual machine environment 100, the platform hardware 102 comprises a computing platform, which may be capable, for example, of executing a standard operating system (OS) or a virtual machine monitor (VMM), such as a VMM 104. The VMM 104, though typically implemented in software, may emulate and export a bare machine interface to higher level software. Such higher level software may comprise a standard or real-time OS, may be a highly stripped down operating environment with limited operating system functionality, or may not include traditional OS facilities. Alternatively, for example, the VMM 104 may be run within, or on top of, another VMM (e.g. in recursive or layered virtual machine environments). In one embodiment, VMMs may also be hosted by an operating system running on platform hardware 102, such as in offerings made by VMWare, Inc. VMMs and their typical features, functionality and variations are well known by those skilled in the art and may be implemented, for example, in software, firmware, hardware or by a combination of various techniques.

The platform hardware 102 can be of a personal computer (PC), mainframe, handheld device, mote/sensor, cellular phone, portable computer (e.g., laptop PC or tablet), set-top box, or any other computing system. As stated above, the platform hardware 102 includes one or more processors 128, 130 and 132 and memory 134. Additionally, platform hardware 102 may include a variety of other input/output devices, not shown in FIG. 1.

The processors 128, 130 and 132 can be any type of processor capable of executing software. This includes processors that are multi-threaded or multi-core, microprocessors, digital signal processors, microcontrollers, or the like, or any combination thereof. The processors may be arranged in various configurations such as symmetric multi-processors (e.g., 2-way, 4-way, 8-way, etc.) or in other communication topologies such as toroidal meshes. Other types of processors and processor topologies may be added or substituted for those described as new types of processors and inter-processor communication topologies are developed and according to the particular application for the virtual machine environment. The processors 128, 130 and 132 may include, but are not necessarily limited to, extensible microcode, macrocode, software, programmable logic, hard coded logic, etc., for performing the execution of embodiments for methods of the present invention. Though only three processors are shown in FIG. 1, it is understood that one, two, three or more processors may be present in the system.

Memory 134 can be any type of recordable/non-recordable media (e.g., random access memory (RAM), read only memory (ROM), magnetic disk storage media, optical storage media, flash memory devices, etc.), as well as electrical, optical, acoustical or other form of propagated signals (e.g., carrier waves, infrared signals, digital signals, etc.), any combination of the above devices, or any other type of machine medium readable by processors 128, 130 and 132. Memory 134 may store instructions and data for performing the execution of method embodiments of the present invention.

The VMM 104 presents a VM (platform) 106 to the “guest” software 116 and 118. The VMM 104 may present the same or different abstraction in VMs 106, 108 and 110. FIG. 1 shows three VMs 106, 108 and 110. The guest software running on each VM, for example, may include a guest OS such as a guest OS 118, 122 and 126 and various guest software applications 116, 120 and 124. Though only three VMs are shown in FIG. 1, it is understood that one, two, three or more VMs may be present in the system.

The guest OSs 118, 122 and 126 expect to access physical resources (e.g., processor registers, memory and input-output (I/O) devices) within corresponding VMs (e.g., VM 106, 108 and 110) on which the guest OSs are running and to perform other functions. For example, the guest OS expects to have access to all registers, caches, structures, I/O devices, memory and the like, according to the architecture of the processor and platform presented in the VM. The resources that can be accessed by the guest software may either be classified as “privileged” or “non-privileged.” For privileged resources, the VMM 104 facilitates functionality desired by guest software while retaining ultimate control over these privileged resources; this is a process otherwise known as “virtualization”. Non-privileged resources do not need to be controlled by the VMM 104 and can be accessed by guest software directly.

Further, each guest OS expects to handle various fault events such as exceptions (e.g., page faults, general protection faults, etc.), interrupts (e.g., hardware interrupts, software interrupts), platform events (e.g., initialization (INIT) and system management interrupts (SMIs)). Some of these fault events are “privileged” because they must be handled by the VMM 104 to ensure proper operation of VMs 106, 108 and 110 and for protection from and among guest software components. Again, this is also part of the platform “virtualization” process performed by the VMM 104.

When a privileged fault event occurs or guest software attempts to access a privileged resource, control may be transferred to the VMM 104. The transfer of control from guest software to the VMM 104 is referred to herein as a VM exit. (Various methods are used to intercept control and are well known in the state of the art.) After facilitating the resource access or handling the event appropriately, the VMM 104 may return control to guest software. (In uniprocessor configurations, for example, where VMs must share a single physical processor, the VMM often uses VM exit points as an opportunity to offer a processor execution time slice to another VM.) The transfer of control from the VMM 104 to guest software is referred to as a VM entry. In one embodiment, the VMM 104 requests the one or more of processors 128, 130 and 132 to perform a VM entry by executing a VM entry instruction.

In one embodiment, the processors 128, 130 and 132 control the operation of the VMs 106, 108 and 110 in accordance with data stored in virtual machine control structure (VMCS) 136. The VMCS 136 is a structure that may contain state of guest software, state of the VMM 104, execution control information indicating how the VMM 104 wishes to control operation of guest software, information controlling transitions between the VMM 104 and a VM, etc. In one embodiment and as shown in FIG. 1, the VMCS 136 is stored in memory 134. In some embodiments, multiple VMCS structures are used to support multiple VMs.

The device VM 112 is a VM that is configured to emulate a hardware device that is typically not present in platform hardware 102. Via device VM 112, embodiments of the present invention provide a mechanism for emulating hardware devices that are used to perform specialized functions or to emulate hardware devices that are not yet available or too expensive.

The device VM 112 may use any combination of hardware and/or software components to emulate the hardware device. Here, the VMM 104 allocates and configures the required resources for the device VM 112 in order for the device VM 112 to emulate the desired hardware device. Further configuration of the resources may also be done by device VM 112. Resource allocation includes reserving a portion or all of a resource. Resources that are reserved include, for example, one or more special registers (e.g. control registers), queues, caches, memory, storage, processing units, execution threads, hyperthreads, complete processors, one of the cores on a multi-core processor, interconnect (e.g. busses and bus bandwidth), network cards, network bandwidth, reconfigurable hardware blocks (e.g. programmable logic arrays (PLAs) and field programmable gate arrays (FPGAs)), etc.

Reservations may be time-slice based where device VM 112 is allocated a certain percentage of a given resource over time. In some cases it will be desireable for these reservations to have real-time guarantees. Reservations may include dedicating resources for exclusive use by device VM 112; such resources are said to be “sequestered” as they are not made available for use to other VMs. Indeed, the existence of sequestered devices might be hidden from other elements of the system (e.g. VMs 106, 108, 110) by the VMM 104, except for device VM 112 for which it is reserved and dedicated to serve. Both VMM 104 and device VM 112 may configure reserved devices to better serve their purposes. Such configurations might include, for example, installing a special microcode/firmware/hardware extension, special purpose microcode, an instruction set extension, or the program for a configurable hardware block or communication interconnect. These configurations may also include software libraries and custom runtime environments and kernels/microkernels, resource schedulers, etc.

The device VM 112 may not be the only VM in the virtual machine environment 100 to have access to the allocated resources. For example, if an execution thread (or processor core) is allocated for the device VM 112, then the device VM 112 may share the execution thread with other VMs in the virtual machine environment 100. The device VM 112 could potentially run a full-fledged operating system or a minimal subset (e.g., microkernel).

As described above, device VM 112 may be used to emulate hardware devices that are used to perform specialized functions or to emulate hardware devices that are not yet available or too expensive. Examples of the functions of these specialized devices may include, but are not limited, a device to accelerate the parsing and handling of XML, a device to accelerate network protocol and payload processing (e.g., TCP/IP termination), a device to accelerate encryption and decryption primitives, and so forth.

The device VM 112 includes device emulation code 114 that facilitates the necessary software to provide the special functionality and configuration to use the allocated resource (e.g., execution thread) as the processing element. One novel aspect of emulating a device with device VM 112 outside of VMM 104 is that it provides the benefits of security and isolation provided by the virtual machine construct. It also permits independent vendors (e.g. non-VMM vendors) to provide emulation devices that can be plugged into a VMM. It also helps remove complexity from the VMM design and improves modularity of design. Thus, bugs or failures in device VM 112, for example, are less likely to crash the VMM 104 or other VMs (e.g. 106, 108, 110) running on the same virtual machine environment 100.

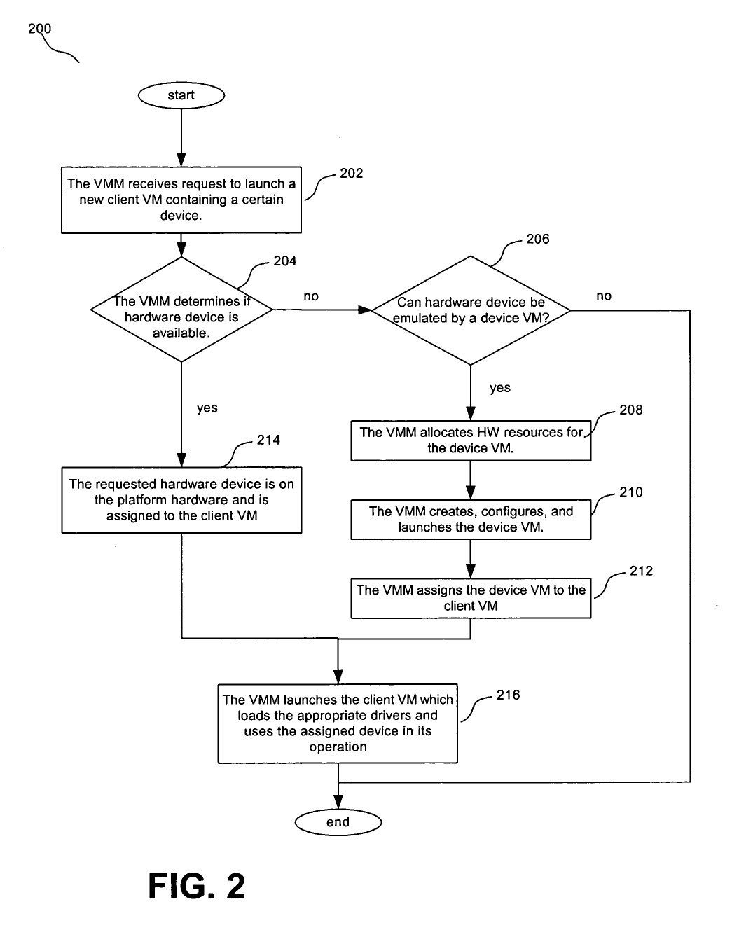

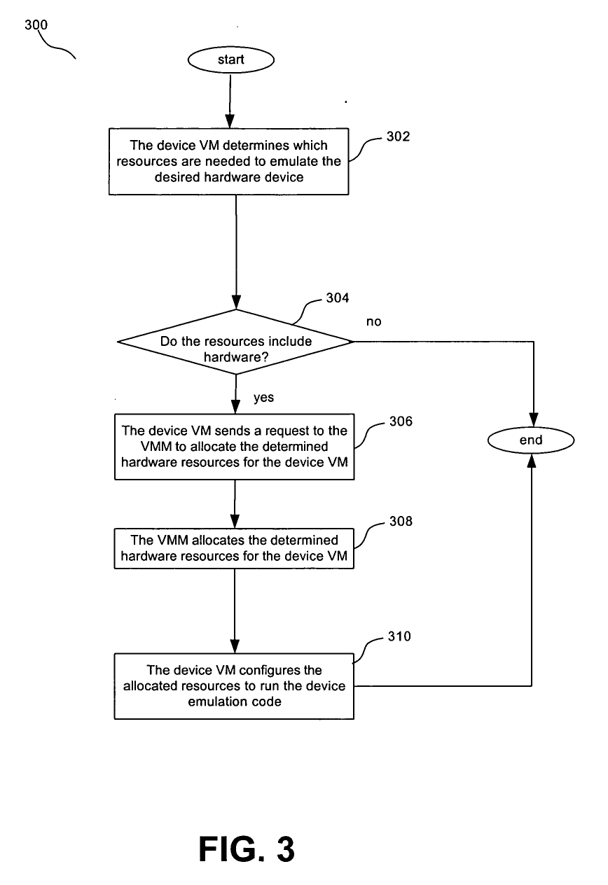

The device emulation code 114 could also include loading and associating special microcode with the special execution thread to provide special instructions which aid in the functionality of the device VM 112. This microcode acceleration would not usually be available to the other threads (or VM's). Once the device VM 112 is configured, it can be treated as a regular hardware device. The VMM 104 can then expose the device VM 112 to one or more VMs (also referred to as a client or guest VM) in the virtual machine environment 100 (other than the device VM 112). When one or more of the VMs enumerate available devices (e.g. during VM “bootstrap” initialization), for example, the device emulated by device VM 112 might be listed. The VM would then use the device VM 112 just as it would any other hardware device. The operation of one embodiment of the present invention is described in more detail next with reference to FIGS. 2 and 3.

FIG. 2 is a flow diagram of one embodiment of a process for launching a new client VM and dynamically assigning (and creating, if needed) a device VM to emulate the required hardware device in a virtual machine environment. Referring to FIG. 2, process 200 begins in processing block 202 with the VMM 104 receiving a request to create a new client VM with certain capabilities and virtual platform features and devices. These capabilities might include specifications for one or more hardware devices. For clarity of presentation, the process 200 illustrates the process for handling one hardware device. Iterations would need to be used if multiple hardware devices were required. If multiple devices are required, then launching of the new client VM would likely be deferred until all devices are allocated successfully. An error might be signaled if all devices cannot be allocated, in which case the new client VM might not be launched and/or correction active is taken and a retry is attempted.

At decision block 204, the VMM 104 determines if the hardware device is available for allocation to the client VM being created. The hardware device could be an existing hardware device or device VM 112 which emulates the hardware device (and has already been instantiated). If such a device is available, then in processing block 214 the device is allocated to the client VM being created. Then in processing block 216 the VMM 104 creates and launches the client VM. The client VM then loads the appropriate drivers and uses the assigned device in its operation. During this time, the VMM 104 may need to allocate other resources to “hook up” the hardware device (e.g., the device VM 112) to the client VM, such as shared memory buffers. Process 200 ends at this point. Note that numerous methods for communication between the client VM, the device VM 112 and the VMM 104 exist, including, but not limited to, shared memory methods, message passing (e.g. networking or busses, including either virtual or physical), etc, and combinations thereof.

If in decision block 204 the VMM 104 does not find a suitable hardware device (actual or emulated), then in decision block 206 the VMM 104 determines if the hardware device can be emulated by device VM 112. For many reasons, the VMM 104 may determine that it is not possible to create a device VM that can satisfy the requirements of the client VM. In this case, the VMM will not create a device VM and will likely report an error condition back to the entity requesting the client VM creation initially. One can imagine, for example, that trying to create a client VM under conditions in which insufficient resources exist or requesting a hardware device whose characteristics/properties are unachievable given available technology on the platform would lead to such an abortive termination of the process 200. Process 200 ends at this point.

If, however, in decision block 206 it is determined that device VM 112 with the appropriate characteristics can be created, the VMM 104 in processing block 208 allocates the requisite hardware resources (e.g. sequestering a thread or processor core) needed to run the device VM 112. Next, in processing block 210, the VMM 104 creates, configures, and launches the device VM 112. The device VM 112 is dynamically created in response to a request for a device needed to provision a new client VM being created. Once the device VM 112 is configured, it is then ready to be given to other VMs (i.e., a client VM) in the virtual machine environment 100 to be used as any other hardware device. In one embodiment, the VMM 104 could potentially report the device VM 112 as a special device on the PCI Bus (e.g. during PCI device enumeration) for one or more of the client VMs 106, 108 and 110. In one embodiment, the communication between the device VM 112 and the client VM is optimized for inter-VM communication (such as shared memory) to overcome the communication overhead.

Then in processing block 212, the VMM 104 assigns the device VM 112 to the client VM. It is likely that blocks 212 and 214 could be merged as they are nearly identical in one embodiment of the invention. The VMM 104 in processing block 216, having created the requisite device for the client VM to use, can now launch the client VM. When the client VM enumerates devices during its startup bootstrap initialization, it will see the device VM 112 and load the appropriate drivers, etc. Process 200 ends at this point. Processing blocks 208, 210, 212 are described in more detail with reference to FIG. 3 below.

In one embodiment, the VMM 104 may be hosted by an operating system (the “VMM hosting OS”) such that the device VM 112 could be allocated to the VMM hosting OS. In such a case, the hosting OS could use the device VM 112 as any other device. The key here is for the device to be made available to the OS when it enumerates devices initially or for the VMM 104 to have a method by which it can update the OS to notify it of the existence of the device VM 112. The former could work, for example, if the VMM 104 boots before the OS, creates the device VM 112, and provides this information to the OS when it boots (e.g. through the Advanced Configuration and Power Interface (ACPI) tables). Then the rest of the VMM as it is hosted by the OS would take over. The latter method would require an interface by which the VMM could notify the OS as to the presence of a new device. This might require some OS, for example, to provide dynamic device enumeration (and device driver) loading. Alternatively, the VMM might provide the requisite device driver and simply modify internal data structures of the OS in appropriate manners.

FIG. 3 is a flow diagram of one embodiment of a process for configuring the device virtual machine 112 (VM) to emulate a desired hardware device (processing blocks 208, 210 and 212 of FIG. 2). Referring to FIG. 3, process 300 begins at processing block 302 where the device VM 112 determines which resources are needed to emulate the desired hardware device. The needed resources may be software only, hardware only or some combination of both.

At decision block 304, if the needed resources include software only then all of the necessary code should already be part of the device emulation code 114 and process 300 ends. Alternatively, if the needed resources include hardware then processing logic proceeds directly to processing block 306.

At processing block 306, the device VM 112 sends a request to the VMM 104 to allocate the determined hardware resources for the device VM 112. For illustration purposes only, assume that the device VM 112 requests that processor 132 be allocated (and sequestered so that device VM 112 has exclusive use of the processor). Then, at processing step 308, the VMM 104 would allocate the determined resource (e.g. processor 132) for the device VM 112. Finally, at processing block 310, the device VM 112 configures the allocated resources (e.g., processor 132) to run the device emulation code 114. Device VM 112 can now be treated as a regular hardware device by other client VMs or the VMM 104. Process 300 ends at this point.

In one embodiment, the present invention could be used to dynamically reconfigure and target a given machine for multiple market segments, where each market segment requires different device configurations (e.g., TCP/IP acceleration, XML parsing acceleration, etc.). This approach may help to eliminate some dedicated hardware accelerators and may help to consolidate server functions into a single physical box.

In another embodiment, the VMM 104 could be designed to include specific instruction-set architecture virtual machine technology (e.g., virtualization of key privileged instructions or state). The VMM 104 could then be used to offer different emulation devices to different VMs. This helps to create richer use models for VM use, as well as product differentiation opportunities. This would help to prevent unauthorized use/abuse of such resources and could be used to maintain centralized control over emulation support software and hardware through the VMM 104 and device VM 112.

In another embodiment of the present invention, the device VM 112 could be used in conjunction with a network processor. Here, the network processor could be allocated (and sequestered) for the device VM 112 and the device VM 112 could emulate an entire network card. In other embodiments, the present invention could be used in both homogeneous and heterogeneous systems. The device VM 112 may be used to emulate one or more homogeneous hardware devices. The device VM 112 may also be used to emulate one or more heterogeneous hardware devices.

A method and system for emulating a hardware device in a virtual machine environment have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method comprising:
configuring a device virtual machine (VM) to emulate a hardware device, wherein the device VM includes device emulation code used to emulate the hardware device.

2. The method of claim 1, wherein the device VM is created dynamically.

3. The method of claim 2, wherein the device VM is created dynamically by a virtual machine monitor (VMM) in response to a request for a device needed to provision a new client VM being created.

4. The method of claim 1, wherein a virtual machine monitor (VMM) uses the device VM as the emulated hardware device.

5. The method of claim 1, wherein a virtual machine monitor (VMM) allocates the device VM to a client VM.

6. The method of claim 1, wherein a client virtual machine (VM) uses the device VM as the emulated hardware device.

7. The method of claim 1, wherein a virtual machine monitor (VMM) allocates the device VM to an operating system (OS) hosting the VMM.

8. The method of claim 1, wherein an operating system (OS) hosting a virtual machine monitor (VMM) uses the device VM to emulate the hardware device.

9. The method of claim 1, wherein the device VM is used to emulate one or more homogeneous hardware devices.

10. The method of claim 1, wherein the device VM is used to emulate one or more heterogeneous hardware devices.

11. The method of claim 1, wherein configuring the device VM to emulate the hardware device comprises:
determining which resources are needed to emulate the hardware device;
if the determined resources include a hardware resource, sending a request to a virtual machine monitor (VMM) to allocate the hardware resource for the device VM; and
configuring the allocated hardware resource to run the device emulation code.

12. The method of claim 11, wherein the device VM and the VMM communicate via shared memory.

13. The method of claim 11, wherein the device VM and a client VM communicate via shared memory.

14. The method of claim 11, wherein the device VM and a client VM communicate via message passing.

15. The method of claim 11, wherein the hardware resource is an allocated processor execution thread.

16. The method of claim 11, wherein the hardware resource is an allocated processor core.

17. The method of claim 11, wherein the hardware resource is an allocated processor.

18. The method of claim 17, wherein the processor is one of a logical processor, a processor core and a stand-alone processor.

19. The method of claim 11, wherein the hardware resource is emulated using special purpose microcode.

20. The method of claim 11, wherein the hardware resource is emulated using firmware.

21. The method of claim 11, wherein the hardware resource is a special-purpose instruction set extension.

22. The method of claim 11, wherein the hardware resource is emulated using a reconfigurable hardware block.

23. The method of claim 11, wherein the device VM and the VMM communicate via message passing.

24. A system comprising:
a device virtual machine (VM) configured to emulate a hardware device, wherein the device VM includes device emulation code used to emulate the hardware device.

25. The system of claim 24, wherein the device VM is created dynamically.

26. The system of claim 25, wherein the device VM is created dynamically by a virtual machine monitor (VMM) in response to a request for a device needed to provision a new client VM being created.

27. The system of claim 24, further comprising a virtual machine monitor (VMM) that uses the device VM as the emulated hardware device.

28. The system of claim 24, further comprising a virtual machine monitor (VMM) that allocates the device VM to a client VM.

29. The system of claim 24, further comprising a client virtual machine (VM) that uses the device VM as the emulated hardware device.

30. The system of claim 24, further comprising a virtual machine monitor (VMM) that allocates the device VM to an operating system (OS) hosting the VMM.

31. The system of claim 24, further comprising an operating system (OS) that hosts a virtual machine monitor (VMM) that uses the device VM to emulate the hardware device.

32. The system of claim 24, wherein the device VM is used to emulate one or more homogeneous hardware devices.

33. The system of claim 24, wherein the device VM is used to emulate one or more heterogeneous hardware devices.

34. A machine-readable medium containing instructions which, when executed by a processing system, cause the processing system to perform a method, the method comprising:
configuring a device virtual machine (VM) to emulate a hardware device, wherein the device VM includes device emulation code used to emulate the hardware device.

35. The machine-readable medium of claim 34, wherein configuring the device VM to emulate the hardware device comprises:
determining which resources are needed to emulate the hardware device;
if the determined resources include a hardware resource, sending a request to a virtual machine monitor (VMM) to allocate the hardware resource for the device VM; and
configuring the allocated hardware resource to run the device emulation code.

36. An apparatus comprising:
a device virtual machine (VM) configured to emulate a hardware device, wherein the device VM includes device emulation code used to emulate the hardware device.

37. The apparatus of claim 36, wherein the device VM is created dynamically.

38. The apparatus of claim 37, wherein the device VM is created dynamically by a virtual machine monitor (VMM) in response to a request for a device needed to provision a new client VM being created.

39. The apparatus of claim 36, wherein the device VM is used to emulate one or more homogeneous hardware devices.

40. The apparatus of claim 36, wherein the device VM is used to emulate one or more heterogeneous hardware devices.
